(19) United States
(12) Patent Application Publication
(10) Pub. No.: US 2008/0305334 A1
(43) Pub. Date: Dec. 11, 2008

(54) CORE/SHELL NANOCRYSTALS AND METHOD FOR PRODUCING THE SAME

(75) Inventors: Eun Joo JANG, Suwon-si (KR); Jung Eun LIM, Yongin-si (KR); Shin Ae JUN, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/932,760

(22) Filed: Oct. 31, 2007

(30) Foreign Application Priority Data
Jun. 7, 2007 (KR) 10-2007-0055496

(51) Int. Cl. B32B 5/16; B05D 1/36

(52) U.S. Cl. 428/402.24; 427/402

(57) ABSTRACT

Disclosed herein are a core/shell nanocrystal and a method for producing the same. More specifically, disclosed herein are a core/shell nanocrystal comprising a metal-doped shell nanocrystal, and a method for producing the same. The core/shell nanocrystal comprises a core nanocrystal and a metal-doped shell nanocrystal formed on the core nanocrystal. Based on the structure, the core/shell nanocrystal exhibits superior crystallinity and high luminescence efficiency, enables easy control of the shape and size and can be produced in a simple manner.

### BACKGROUND OF THE INVENTION

This non-provisional application claims priority under 35 U.S.C. § 119 to Korean Patent Application No. 10-2007-0055496, field on Jun. 7, 2007 in the Korean Intellectual Property Office (KIPO), the entire contents of which are incorporated herein by reference.

1. Field of the Invention

Example embodiments include a core/shell nanocrystal and a method for producing the same. Other example embodiments include a core/shell nanocrystal comprising a metal-doped shell nanocrystal and a method for producing the same.

2. Description of the Related Art

A nanocrystal is defined as a crystalline material having a size of a few nanometers, and consists of several hundred to several thousand atoms. Since such a small-sized nanocrystal has a large surface area per unit volume, most of the constituent atoms of the nanocrystal are present on the surface of the nanocrystal. Based on this characteristic structure, a nanocrystal exhibits quantum confinement effects and shows electrical, magnetic, optical, chemical and mechanical properties different from those inherent to the constituent atoms of the nanocrystal. Control over the physical size enables the control of the properties of the nanocrystals.

Vapor deposition processes, including metal organic chemical vapor deposition (MOCVD) and molecular beam epitaxy (MBE), have been used to prepare nanocrystals. In recent years, a wet chemistry technique wherein a precursor material is added to an organic solvent to grow a nanocrystal has made remarkable progress. According to the wet chemistry technique, as a crystal is grown, a dispersant is coordinated to the surface of the crystal to control the crystal growth. Accordingly, the wet chemistry technique has an advantage in that nanocrystals can be uniformly prepared in size and shape in a relatively simple manner at low cost, compared to conventional vapor deposition processes, e.g., MOCVD and NBE.

A great deal of research has been made on a core/shell structured nanocrystalline semiconductor material with increased luminescence efficiency and a method for preparing the nanocrystalline material.

U.S. Pat. No. 6,322,901 discloses a core/shell structured semiconductor nanocrystalline material with improved luminescence efficiency. U.S. Pat. No. 6,207,229 discloses a method for preparing a core/shell structured semiconductor nanocrystalline material. The semiconductor compound nanocrystal prepared by the method was reported to show a 30% to 50% increase in luminescence efficiency. Based on the phenomenon that energy transitions in semiconductor nanocrystals mainly occur at the edge of energy bandgaps, the prior art techniques state that the nanocrystals emit light of pure wavelengths with high efficiency and can thus be used in the fabrication of displays and biological imaging sensors.

U.S. Patent Publication No. 2003-0010987 discloses a semiconductor core/shell nanocrystal, in which a core contains at least one dopant, as shown in FIG. 1. U.S. Patent Publication No. 2006-0216759 discloses a metal oxide-doped fluorescent nanocrystal and a coating material-containing fluorescent nanocrystal. Japanese Patent Publication No. 2006-0524727 discloses a doped core/shell luminescent nanoparticle. Korean Patent Publication No. 2006-0007372 discloses a nanoparticle in which a core zone is uniformly doped with a dopant.

These prior arts disclose a core/shell nanocrystal, in which a core is doped with a dopant. However, this nanocrystal has disadvantages in that the shape of a core nanocrystal is difficult to control and the nanocrystal structure exhibits low luminescence efficiency due to inherently low luminescence efficiency of the core.

Accordingly, example embodiments of the present invention include a core/shell nanocrystal that enables the shape of a core nanocrystal to be controlled by using a bare core and comprises a doped-shell nanocrystal exhibiting high luminescence efficiency by which the shell nanocrystal is doped with a dopant while being grown on the core nanocrystal.

### SUMMARY OF THE INVENTION

Therefore, example embodiments of the present invention include a core/shell nanocrystal that exhibits superior reproducibility and high luminescence efficiency and enables easy control of cystallinity, size and shape of the nanocrystal, which comprises a core nanocrystal and a metal-doped shell nanocrystal formed on the core nanocrystal.

In accordance with example embodiments of the present invention, there is provided a core/shell nanocrystal comprising: (a) a core nanocrystal; and (b) a metal-doped shell nanocrystal formed on the core nanocrystal.

The core/shell nanocrystal may further comprise a passivation shell nanocrystal.

In accordance with example embodiments of the present invention, there is provided a method for preparing a core/shell nanocrystal comprising: (a) forming a core nanocrystal; and (b) growing a metal-doped shell nanocrystal on the surface of the core nanocrystal.

In accordance with example embodiments of the present invention, there is provided an electronic device comprising the core/shell nanocrystal.

### BRIEF DESCRIPTION OF THE DRAWINGS

Example embodiments will be more clearly understood from the following detailed description taken in conjunction with the accompanying drawings. FIGS. 1-9 represent non-limiting, example embodiments as described herein.

FIG. 1 is a schematic diagram of a core/shell nanocrystal comprising a doped core according to the prior art;

FIG. 2 is a schematic diagram of a core/shell nanocrystal comprising a doped shell according to one example embodiment of the present invention;

FIG. 3 is a schematic diagram of a core/shell nanocrystal comprising a passivation shell in addition to a doped shell according to another example embodiment of the present invention;

FIG. 4 is a TEM image of a doped-shell core/shell nanocrystal obtained in Example 1;

FIG. 5 is PL spectra of a doped-shell core/shell nanocrystal obtained in Example 1;

FIG. 6 is a TEM image of a shell-doped core/shell nanocrystal comprising a passivation shell obtained in Example 2;

FIG. 7 is a PL spectra of a shell-doped core/shell nanocrystal comprising a passivation shell obtained in Example 2;

FIG. 8 is a TEM image of a nanocrystal obtained in Comparative Example 1; and

FIG. 9 is PL spectra of a nanocrystal obtained in Comparative Example 1.

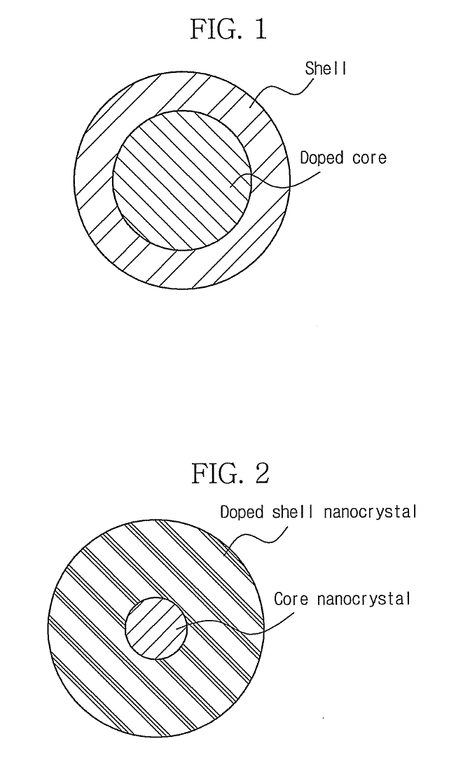

### DESCRIPTION OF THE PREFERRED EMBODIMENTS

The present invention will now be described in greater detail with reference to the accompanying drawings.

Example embodiments are directed to a core/shell nanocrystal comprising: (a) a core nanocrystal; and (b) a metal-doped shell nanocrystal formed on the core nanocrystal.

By doping luminescent nanocrystals with a dopant, the absorbance and luminescence wavelengths of the nanocrystals can be controlled within a desired range. Nanocrystals well-known to date in the art that absorb and emit light in ultraviolet and infrared regions contain a heavy metal (e.g. lead or cadmium) and have a high possibility of falling under environmental regulations as an environmentally harmful material. However, there is no semiconductor nanocrystalline material capable of exhibiting these properties while containing no heavy metal. The doping of luminescent nanocrystals with a dopant enables control of the absorbance and luminescence wavelengths of the nanocrystals. But, semiconductor nanocrystals containing no heavy metal are known to be significantly difficult in controlling the size, shape and crystallinity, as compared to the cases containing heavy metals.

FIG. 2 shows the structure of a core/shell nanocrystal comprising a doped-shell nanocrystal according to example embodiments. Example embodiments of such core/shell nanocrystal include use of a core nanocrystal having a size of 1 to 4 nm. The core nanocrystal promotes growth of the metal-doped shell nanocrystal and improves luminescence efficiency of a final core/shell nanocrystal. In addition, a heavy metal (e.g. lead or cadmium) is used in synthesis of the core nanocrystal, thereby enabling easy control of the size, shape and crystallinity of the nanocrystal. Furthermore, a heavy metal-free shell nanocrystal is then doped with a metal while it is grown on the core nanocrystal, thereby realizing a core/shell nanocrystal exhibiting improved properties while making the content of an environmentally toxic material as low as possible. As a result, more superior physical properties can be imparted to a core/shell nanocrystal wherein a region where there is no core nanocrystal is doped.

A material for the core nanocrystal is not particularly limited, but may be generally selected from Group 12-16, Group 13-15 and Group 14-16 compounds and mixtures thereof. A material for the shell nanocrystal is not particularly limited, but may be generally selected from Group 12-16, Group 13-15 and Group 14-16 compounds and mixtures thereof.

Specific examples of materials for the core and shell nanocrystals include, but are not limited to CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs, and a mixture thereof.

As the core nanocrystal material, preferred is the use of a high-reactivity material capable of easily producing a core under a low concentration to promote crystal growth. As the shell nanocrystal material, preferred is the use of a low-reactivity material that is grown on the formed core and produces no core separately from the core nanocrystal.

Any dopant metal may be used in the doping of the shell nanocrystal without particular limitation so long as it changes the luminescence wavelength of the shell nanocrystal. Examples of the metal include, but are not limited to: transition metals selected from scandium (Sc), titanium (Ti), vanadium (V), chromium (Cr), manganese (Mn), iron (Fe), cobalt (Co), nickel (Ni), copper (Cu) and zinc (Zn); precious metals selected from gold (Au), silver (Ag), platinum (Pt) and iridium (Ir); alkali metals selected from lithium (Li), sodium (Na), potassium (K), rubidium (Rb), cesium (Cs) and francium (Fr); and mixtures thereof.

In example embodiments, the amount of the metal doped into the shell nanocrystal is within a range from about 0.1 to about 5 wt % and varies depending on the type of the dopant and shell nanocrystal.

The shell-doped core/shell nanocrystal of example embodiments may have a shape e.g. a sphere, a disc, a cube, pyramid or a cylinder and may have a diameter of 2 nm to 20 nm.

The absorbance and luminescence wavelengths of the core/shell nanocrystal are preferably within a range from 200 nm to 2,000 nm, and more preferably within a range from 300 nm to 1,600 nm. The absorbance and luminescence efficiencies of the core/shell nanocrystal are preferably equal to or higher than 1%, and more preferably equal to or higher than 20%.

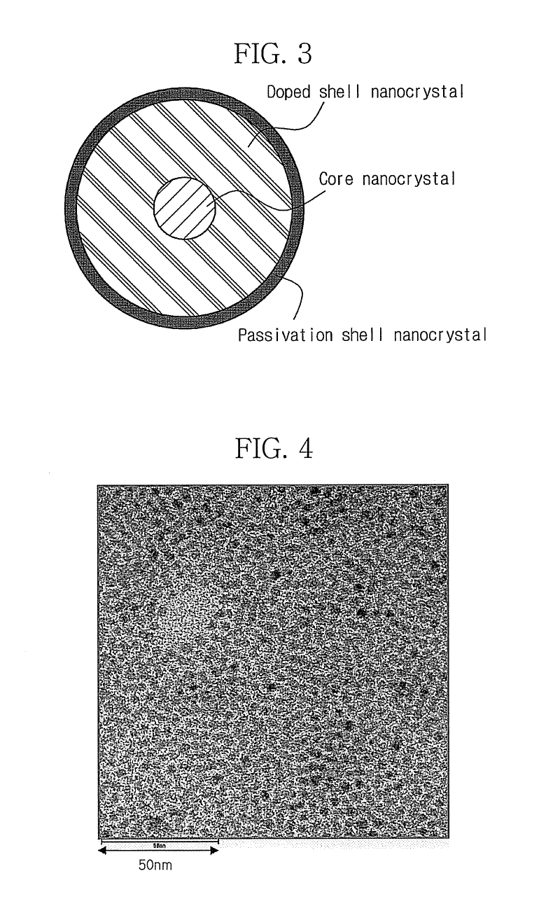

Example embodiments are directed to a core/shell nanocrystal further comprising a passivation shell nanocrystal formed on the shell nanocrystal. The structure of such a nanocrystal is shown in FIG. 3. The passivation shell nanocrystal is composed of a material that has bandgaps greater than those of the shell nanocrystal or a material that has a lower oxidation tendency. Based on the passivation effect that is caused by the passivation shell, the luminescence property of the metal-doped shell nanocrystal can be maintained and the luminescence efficiency of the metal-doped shell nanocrystal can be further improved owing to quantum confinement effects.

A material for the passivation shell nanocrystal is not particularly limited, but may be generally selected from Group 12-16, Group 13-15 and Group 14-16 compounds and mixtures thereof.

Example embodiments are directed to a method for producing a core/shell nanocrystal comprising a metal-doped shell nanocrystal.

The method comprises (a) forming a core nanocrystal; and (b) growing a metal-doped shell nanocrystal on the surface of the core nanocrystal.

Specifically, the formation of the core nanocrystal in step (a) may be carried out according to production methods commonly used in the art. The growth of the shell nanocrystal in step (b) is carried out by adding precursors for constituent elements of an intended shell nanocrystal material to a solvent and mixing the precursors with a dopant precursor solution and the core nanocrystal prepared in step (a) to react with each other. During mixing of the solvent with element precursors, a dispersant may be further added thereto. The reactants may be sequentially or simultaneously mixed with one another and sub-steps in step (b) may be carried out in any order.

More specifically, for example, step (b) may be carried out in the following procedure. After a core nanocrystal is formed, a metal precursor for a shell nanocrystal is mixed with a solvent and the mixture is heated to prepare a metal precursor solution. A dopant precursor solution and the core nanocrystal are sequentially or simultaneously added to the metal precursor solution. Then, a non-metal precursor solution for a shell nanocrystal is added to the reaction mixture to react with each other with stirring, thereby growing the metal-doped shell nanocrystal on the surface of the core nanocrystal. The step (b) is not necessarily limited to the sub-step order.

The core and shell nanocrystals that may be used in the method of example embodiment are not particularly limited, but may be generally selected from Group 12-16, Group 13-15 and Group 14-16 compounds and mixtures thereof. Specifically, the core and shell nanocrystals may be selected from the group consisting of CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs and mixtures thereof, but are not necessarily limited thereto.

Examples of the metal precursor that can be used in formation of the core and shell nanocrystals include, but are not limited to dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium acetate, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, lead acetate, lead bromide, lead chloride, lead fluoride, lead oxide, lead perchlorate, lead nitrate, lead sulfate, lead carbonate, tin acetate, tin bisacetylacetonate, tin bromide, tin chloride, tin fluoride, tin oxide, tin sulfate, germanium tetrachloride, germanium oxide, germanium ethoxide, gallium acetylacetonate, gallium chloride, gallium fluoride, gallium oxide, gallium nitrate, gallium sulfate, indium chloride, indium oxide, indium nitrate and indium sulfate.

Examples of the non-metal precursor that can be used in formation of the core and shell nanocrystals include, but are not limited to alkyl thiol compounds (e.g., hexane thiol, octane thiol, decane thiol, dodecane thiol, hexadecane thiol and mercaptopropyl silane), sulfur-trioctylphosphine (S-TOP), sulfur-tributylphosphine (S-TBP), sulfur-triphenylphosphine (S-TPP), sulfur-trioctylamine (S-TOA), trimethylsilyl sulfur, ammonium sulfide, sodium sulfide, selenium-trioctylphosphine (Se-TOP), selenium-tributylphosphine (Se-TBP), selenium-triphenylphosphine (Se-TPP), tellurium-tributylphosphine (Te-TBP), tellurium-triphenylphosphine (Te-TPP), trimethylsilyl phosphine, alkyl phosphines (e.g., triethylphosphine, tributylphosphine, trioctylphosphine, triphenylphosphine and tricyclohexylphosphine), arsenic oxide, arsenic chloride, arsenic sulfate, arsenic bromide, arsenic iodide, nitric oxide, nitric acid and ammonium nitrate.

Examples of the solvent that can be used in step (b) of the method according to example embodiments include: C₆₋₂₄ primary alkyl amines, C₆₋₂₄ secondary alkyl amines, C₆₋₂₄ tertiary alkyl amines, C₆₋₂₄ primary alcohols, C₆₋₂₄ secondary alcohols, C₆₋₂₄ tertiary alcohols, C₆₋₂₄ ketones and esters, C₆₋₂₄ heterocyclic compounds containing nitrogen or sulfur, C₆₋₂₄ alkanes, C₆₋₂₄ alkenes, C₆₋₂₄ alkynes, tributylphosphine, trioctylphosphine and trioctylphosphine oxide.

In the method according to example embodiments, any dopant metal may be used in the doping of the shell nanocrystal without particular limitation so long as it changes the luminescence wavelength of the shell nanocrystal. Examples of the dopant metal include, but are not limited to: transition metals including scandium (Sc), titanium (Ti), vanadium (V), chromium (Cr), manganese (Mn), iron (Fe), cobalt (Co), nickel (Ni), copper (Cu) or zinc (Zn); precious metals including gold (Au), silver (Ag) platinum (Pt) or iridium (Ir); alkali metals including lithium (Li), sodium (Na), potassium (K), rubidium (Rb), cesium (Cs) or francium (Fr); and mixtures thereof.

Examples of the dopant precursor that can be used in the method according to example embodiments include, but are not limited to: metal salts including halides, acetates, acetylacetonate or chalcogenides; and organic complex compounds.

In example embodiments, the amount of the metal doped into the shell nanocrystal is within a range from about 0.1 to about 5 wt % and varies depending on the type of the dopant and shell nanocrystal.

Examples of the dispersant that can be used in step (b) of the method according to example embodiments include: C₆-C₂₄ alkanes or alkenes having a terminal carboxyl (COOH) group; C₆-C₂₄ alkanes or alkenes having a terminal phosphoryl (POOH) group; C₆-C₂₄ alkanes or alkenes having a terminal sulfhydryl (SOOH) group; and C₆-C₂₄ alkanes or alkenes having a terminal amino (—NH₂) group.

Specific examples of the dispersant include oleic acid, stearic acid, palmitic acid, hexylphosphonic acid, n-octylphosphonic acid, tetradecylphosphonic acid, octadecylphosphonic acid, n-octylamine and hexadecylamine.

To promote crystal growth and to ensure the stability of the solvent, the step (b) according to the method of example embodiments is carried out at 100° C. to 460° C., preferably at 120° C. to 390° C., and more preferably at 150° C. to 360° C.

To obtain desired absorption and luminescence efficiencies, the step (b) according to the method of example embodiments is carried out for 20 seconds to 72 hours, preferably for 5 minutes to 24 hours, and more preferably for 30minutes to 8 hours.

The method for preparing a core/shell nanocrystal of example embodiments may further comprise (c) forming a passivation shell nanocrystal on the shell nanocrystal. The passivation shell nanocrystal is composed of a material that has bandgaps greater than those of the shell nanocrystal or a material that has a lower oxidation tendency. Similar to the case of the shell nanocrystal, the passivation shell nanocrystal is formed by adding a precursor to a solvent and mixing the precursor solution with the core/shell nanocrystal to react with each other.

The core/shell nanocrystal comprising a metal-doped shell nanocrystal according to example embodiments can be utilized in a variety of applications including displays, sensors and energy fields.

Hereinafter, the present invention will be explained in more detail with reference to the following examples. However, these examples are given for the purpose of illustration and are not intended to limit the present invention.

### EXAMPLES

### Example 1

### Growth of Cu-doped ZnSe Shell Nanocrystal on CdSe Core Nanocrystal <CdSe/(ZnSe:Cu)>

10 mL of trioctylamine (hereinafter, referred to as “TOA”), 0.067 g of octadecyl phosphonic acid and 0.0062 g of cadmium oxide were simultaneously put in a 100 ml-flask equipped with a reflux condenser. The reaction temperature of the mixture was adjusted to 300° C. with refluxing to prepare a cadmium precursor solution. Separately, a selenium (Se) powder was dissolved in trioctylphosphine (TOP) to obtain a Se-TOP complex solution (Se concentration: ca. 2 M). 1 ml of the 2M Se-TOP complex solution was rapidly fed to the refluxing mixture and the reaction was allowed to proceed for about 2 minutes.

After the reaction was completed, the reaction mixture was cooled to room temperature as rapidly as possible. Ethanol as a non-solvent was added to the reaction mixture, and the resulting mixture was centrifuged. The obtained precipitate was separated from the supernatant and was dispersed in toluene to prepare a CdSe core nanocrystal solution.

0.063 g of zinc stearate (Zn(St)₂) and 10 mL of octadecene (ODE) were put in a reactor and heated under a nitrogen atmosphere at 300° C.

After a solution (0.01 M, 0.1 mL) of copper acetate in ODE, and a mixture of the CdSe nanocrystal solution (0.26 mL) and ODE (0.24 mL) were sequentially fed into the reactor, a mixture of a Se-TOP solution (0.2 M, 0.5 mL) and ODE (0.5 mL) was fed into the reactor. The reaction was allowed to proceed at 300° C. for 30 minutes.

After the reaction was completed, the reaction mixture was cooled to room temperature as rapidly as possible. Ethanol as a non-solvent was added to the reaction mixture, and the resulting mixture was centrifuged. The obtained precipitate was separated from the supernatant and was dispersed in toluene to obtain a desired CdSe/(ZnSe:Cu) nanocrystal.

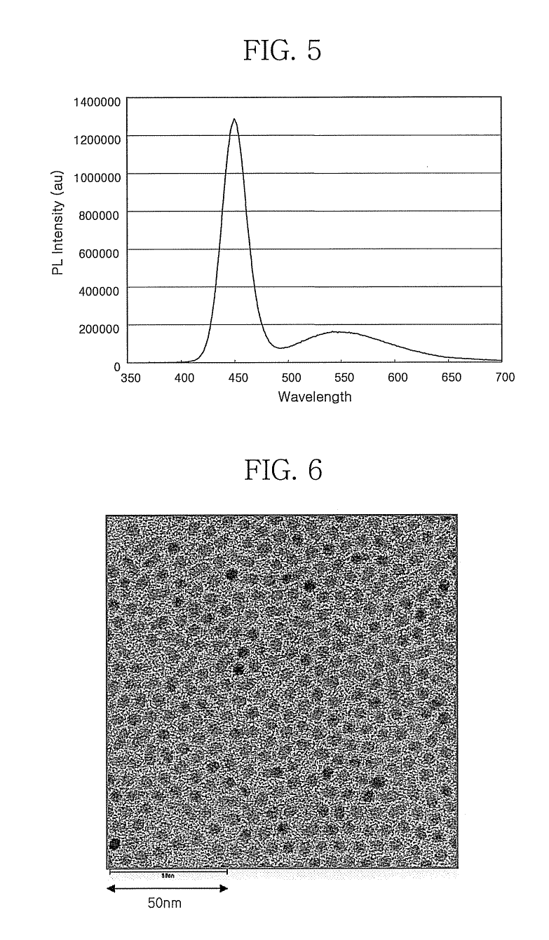

The TEM image and photoluminescence spectra of the CdSe/(ZnSe:Cu) nanocrystal are shown in FIGS. 4 and 5, respectively. It can be confirmed from FIG. 5 that the luminescence wavelength of the bare ZnSe nanocrystal is 450 nm and the luminescence wavelength derived from Cu doping is observed at 550 nm.

### Example 2

### Growth of Cu-doped ZnSe Shell Nanocrystal on CdSe Core Nanocrystal and Passivation by ZnS Layer <CdSe/(ZnSe:Cu)/ZnS>

The core nanocrystal prepared in Example 1 was used herein.

0.063 g of zinc stearate (Zn(St)₂) and 10 mL of ODE were put into a reactor and heated under vacuum at 120° C. for 20 minutes. After a solution (0.01 M, 0.1 mL) of copper acetate in ODE and a mixture of the CdSe nanocrystal solution (0.26 mL) and ODE (0.24 mL) were sequentially fed into the reactor, a mixture of a Se-TOP solution (0.2 M, 0.5 mL) and ODE (0.5 mL) was fed into the reactor. The reaction was allowed to proceed at 180° C. for one hour and at 260° C. for one hour. Then, a mixture of zinc acetate (0.1M, 1 ml), tributylphosphine (hereinafter, referred to as “TBP”, 1 mL) and ODE (1 mL), and a mixture of a S-TOP solution (0.4 M, 1 mL) and ODE (1 mL) were sequentially fed to the reactor. The reaction was allowed to proceed at 260° C. for one hour and at 300° C. for one hour.

After the reaction was completed, the reaction mixture was cooled to room temperature as rapidly as possible. Ethanol as a non-solvent was added to the reaction mixture, and the resulting mixture was centrifuged. The obtained precipitate was separated from the supernatant and was dispersed in toluene to obtain a desired CdSe/(ZnSe:Cu)/ZnS nanocrystal.

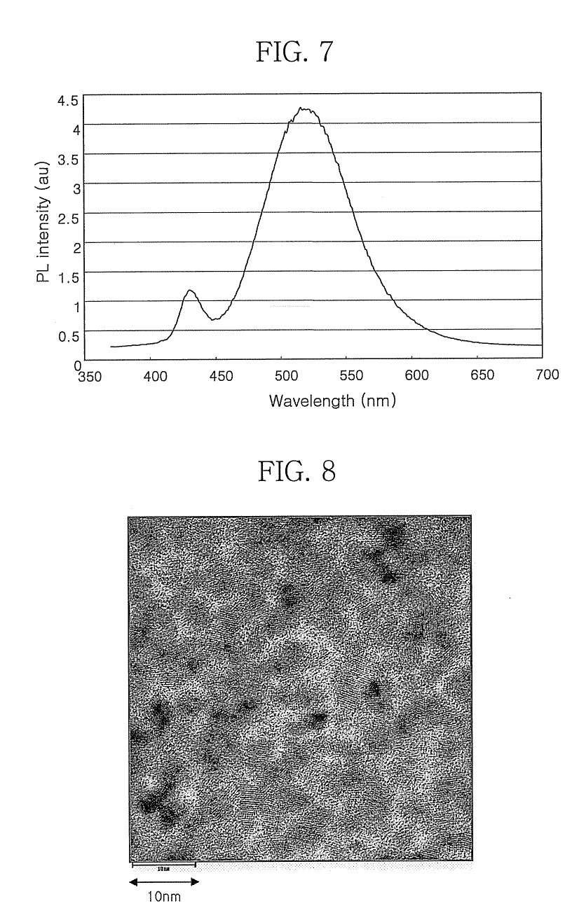

The TEM and photoluminescence spectra of the CdSe/(ZnSe:Cu)/ZnS nanocrystal are shown in FIGS. 6 and 7, respectively. It can be seen from photoluminescence spectra in FIG. 7 that the luminescence wavelength of the bare ZnSe nanocrystal is 450 nm and the luminescence wavelength derived from Cu doping is observed at 550 nm, and ZnS coating leads to improvement in luminescence efficiency of the luminescence wavelength reflecting Cu doping.

### Comparative Example 1

### Synthesis of ZnSe:Cu Nanocrystal

0.054 g of Zn(St)₂ and 8 g of ODE were put into a reactor and heated under a nitrogen atmosphere at 300° C. A solution of a Se powder (0.032 g) and ODE (0.1 g) in TBP (1.5 g) was fed into the reactor. The reaction was allowed to proceed for 5 minutes and the reaction temperature was decreased to 180° C. After a solution (0.01 M, 0.1 mL) of copper acetate in ODE was fed into the reactor, the reaction was allowed to proceed for one hour. After a 0.05M solution of zinc acetate (Zn(oAc)₂) in TBP was fed into the reactor at a rate of 1 ml/min, the reaction temperature was elevated to about 240° C. and the reaction was allowed to proceed for 90 minutes. Then, the Zn solution was further fed into the reactor and allowed to react for 2 hours.

After the reaction was completed, the reaction mixture was cooled to room temperature as rapidly as possible. Ethanol as a non-solvent was added to the reaction mixture, and the resulting mixture was centrifuged. The obtained precipitate was separated from the supernatant and was dispersed in toluene to obtain a desired ZnSe:Cu nanocrystal.

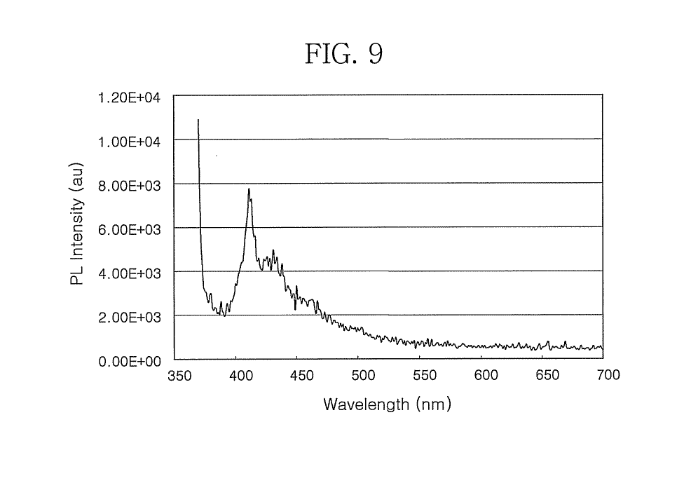

The TEM of the ZnSe:Cu nanocrystal thus obtained is shown in FIG. 8. Photoluminescence spectra were obtained for the nanocrystal sampled at each step. The result is shown in FIG. 9. It can be seen from FIG. 8 that the nanocrystal comprising no core exhibits poor crystallinity. It can be confirmed from FIG. 9 that a spectrum (i.e. peak plotted at a wavelength slightly longer than 400 nm) corresponding to the luminescence of the ZnSe nanocrystal showed a significantly low efficiency and no luminescence wavelength derived from Cu doping was observed.

The results of Examples and Comparative Examples indicate that the core/shell nanocrystal comprising a metal-doped shell nanocrystal according to example embodiments exhibits superior crystallinity and high luminescence efficiency.

As apparent from the foregoing, the core/shell nanocrystal according to example embodiments comprises a core nanocrystal and a metal-doped shell nanocrystal formed on the core nanocrystal. Based on the structure, the core/shell nanocrystal exhibits superior crystallinity and high luminescence efficiency, enables easy control of the shape and size and can be produced in a simple manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A core/shell nanocrystal comprising:
(a) a core nanocrystal; and
(b) a metal-doped shell nanocrystal formed on the core nanocrystal.

2. The core/shell nanocrystal according to claim 1, wherein the core nanocrystal is composed of a Group 12-16 compound, a Group 13-15 compound, a Group 14-16 compound or a mixture thereof.

3. The core/shell nanocrystal according to claim 1, wherein the shell nanocrystal is composed of a Group 12-16 compound, a Group 13-15 compound, a Group 14-16 compound or a mixture thereof.

4. The core/shell nanocrystal according to claim 1, wherein the core nanocrystal is composed of one selected from the group consisting of CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs and a mixture thereof.

5. The core/shell nanocrystal according to claim 1, wherein the shell nanocrystal is composed of one selected from the group consisting of CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs and a mixture thereof.

6. The core/shell nanocrystal according to claim 1, wherein the metal used as a dopant is selected from the group consisting of: a transition metal including scandium (Sc), titanium (Ti), vanadium (V), chromium (Cr), manganese (Mn), iron (Fe), cobalt (Co), nickel (Ni), copper (Cu) or zinc (Zn); a precious metal including gold (Au), silver (Ag) platinum (Pt) or iridium (fr); an alkali metal including lithium (Li), sodium (Na), potassium (K), rubidium (Rb), cesium (Cs) or francium (Fr); and a mixture thereof.

7. The core/shell nanocrystal according to claim 1, further comprising:
a passivation shell nanocrystal formed on the shell nanocrystal.

8. The core/shell nanocrystal according to claim 7, wherein the passivation shell nanocrystal is composed of a material having bandgaps greater than those of the shell nanocrystal or a material having a lower oxidation tendency.

9. The core/shell nanocrystal according to claim 7, wherein the passivation shell nanocrystal is composed of one selected from Group 12-16, Group 13-15, Group 14-16 compounds and mixtures thereof.

10. A method for preparing a core/shell nanocrystal comprising:
(a) forming a core nanocrystal; and
(b) growing a metal-doped shell nanocrystal on the surface of the core nanocrystal.

11. The method according to claim 10, wherein step (b) is carried out by adding a metal precursor, a non-metal precursor and a dopant precursor, constituting a shell nanocrystal, to a solvent and mixing the precursor solution with the core nanocrystal obtained in step (a) to react with each other.

12. The method according to claim 11, wherein a dispersant is further added to the solvent.

13. The method according to claim 10, wherein the core nanocrystal is composed of a Group 12-16 compound, a Group 13-15 compound, a Group 14-16 compound or a mixture thereof.

14. The method according to claim 10, wherein the shell nanocrystal is composed of a Group 12-16 compound, a Group 13-15 compound, a Group 14-16 compound or a mixture thereof.

15. The method according to claim 10, wherein the core nanocrystal is composed of one selected from the group consisting of CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs, and a mixture thereof.

16. The method according to claim 10, wherein the shell nanocrystal is composed of one selected from the group consisting of CdS, CdSe, CdTe, ZnS, ZnSe, ZnTe, HgS, HgSe, HgTe, PbS, PbSe, PbTe, AlN, AlP, AlAs, GaN, GaP, GaAs, InN, InP, InAs, and a mixture thereof.

17. The method according to claim 10, wherein the metal used as a dopant is selected from the group consisting of: a transition metal including scandium (Sc), titanium (Ti), vanadium (V), chromium (Cr), manganese (Mn), iron (Fe), cobalt (Co), nickel (Ni), copper (Cu) or zinc (Zn); a precious metal including gold (Au), silver (Ag) platinum (Pt) or iridium (Ir); an alkali metal including lithium (Li), sodium (Na), potassium (K), rubidium (Rb), cesium (Cs) or francium (Fr); and a mixture thereof.

18. The method according to claim 11, wherein the metal precursor is selected from the group consisting of dimethyl zinc, diethyl zinc, zinc acetate, zinc acetylacetonate, zinc iodide, zinc bromide, Zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium acetate, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, lead acetate, lead bromide, lead chloride, lead fluoride, lead oxide, lead perchlorate, lead nitrate, lead sulfate, lead carbonate, tin acetate, tin bisacetylacetonate, tin bromide, tin chloride, tin fluoride, tin oxide, tin sulfate, germanium tetrachloride, germanium oxide, germanium ethoxide, gallium acetylacetonate, gallium chloride, gallium fluoride, gallium oxide, gallium nitrate, gallium sulfate, indium chloride, indium oxide, indium nitrate and indium sulfate.

19. The method according to claim 11, wherein the non-metal precursor is selected from the group consisting of hexane thiol, octane thiol, decane thiol, dodecane thiol, hexadecane thiol, mercaptopropyl silane, sulfur-trioctylphosphine (S-TOP), sulfur-tributylphosphine (S-TBP), sulfur-triphenylphosphine (S-TPP), sulfur-trioctylamine (S-TOA), trimethylsilyl sulfur, ammonium sulfide, sodium sulfide, selenium-trioctylphosphine (Se-TOP), selenium-tributylphosphine (Se-TBP), selenium-triphenylphosphine (Se-TPP), tellurium-tributylphosphine (Te-TBP), tellurium-triphenylphosphine (Te-TPP), trimethylsilyl phosphine, alkyl phosphines including triethylphosphine, tributylphosphine, trioctylphosphine, triphenylphosphine or tricyclohexylphosphine, arsenic oxide, arsenic chloride, arsenic sulfate, arsenic bromide, arsenic iodide, nitric oxide, nitric acid and ammonium nitrate.

20. The method according to claim 11, wherein the solvent is selected from the group consisting of C₆₋₂₄ primary alkyl amines, C₆₋₂₄ secondary alkyl amines, C₆₋₂₄ tertiary alkyl amines, C₆₋₂₄ primary alcohols, C₆₋₂₄ secondary alcohols, C₆₋₂₄ tertiary alcohols, C₆₋₂₄ ketones, C₆₋₂₄ esters, C₆₋₂₄ heterocyclic compounds containing nitrogen or sulfur, C₆₋₂₄ alkanes, C₆₋₂₄ alkenes, C₆₋₂₄ alkynes, tributylphosphine, trioctylphosphine and trioctylphosphine oxide.

21. The method according to claim 11, wherein the dispersant is selected from the group consisting of C₆-C₂₄ alkanes or alkenes having a terminal carboxyl (COOH) group; C₆-C₂₄ alkanes or alkenes having a terminal phosphoryl (POOH) group; C₆-C₂₄ alkanes or alkenes having a terminal sulfhydryl (SOOH) group; and C₆-C₂₄ alkanes or alkenes having a terminal amino (−NH₂) group.

22. The method according to claim 11, wherein the dispersant is selected from the group consisting of oleic acid, stearic acid, palmitic acid, hexylphosphonic acid, n-octylphosphonic acid, tetradecylphosphonic acid, octadecylphosphonic acid, n-octyl amine and hexadecylamine.

23. The method according to claim 10, further comprising:
(c) forming a passivation shell nanocrystal on the shell nanocrystal.

24. The method according to claim 23, wherein the passivation shell nanocrystal is composed of a material having bandgaps greater than those of the shell nanocrystal or a material having a lower oxidation tendency.

25. The method according to claim 23, wherein the shell nanocrystal is composed of one selected from Group 12-16, Group 13-15 and Group 14-16 compounds and mixtures thereof.
